(19) United States
(12) Patent Application Publication
(10) Pub. No.: US 2017/0330379 A1
(43) Pub. Date: Nov. 16, 2017

(54) METHODS AND SYSTEMS FOR DISPLAYING VIRTUAL REALITY CONTENT IN A VEHICLE

(71) Applicant: GM GLOBAL TECHNOLOGY OPERATIONS LLC, Detroit, MI (US)

(72) Inventors: GERALD M. BOJANOWSKI, WASHINGTON TOWNSHIP, MI (US); JULIEN P. MOUROU, BLOOMFIELD HILLS, MI (US); RALPH STENGER, MAINHAUSEN (DE); MARKUS LANGER, DARMSTADT (DE)

(73) Assignee: GM GLOBAL TECHNOLOGY OPERATIONS LLC, Detroit, MI (US)

(21) Appl. No.: 15/155,972

(22) Filed: May 16, 2016

(51) Int. Cl. G06T 19/00; B60K 35/00; G06F 3/16; H04N 5/232

(52) U.S. Cl. CPC G06T 19/006; H04N 5/232; B60K 35/00; G06F 3/162; B60K 2350/352

(57) ABSTRACT

Methods and systems are provided for providing a virtual reality experience to an occupant of a vehicle. In one embodiment, a system includes a high definition screen associated with a component of a passenger compartment of the vehicle. The system further includes a control module communicatively coupled to the screen and configured to generate control signals that control virtual reality content to be displayed on the high definition screen.

### TECHNICAL FIELD

The technical field generally relates to vehicles, and more particularly relates to methods and systems for displaying virtual reality content in a vehicle.

### BACKGROUND

Sunroof systems of a vehicle can be costly to implement. In addition, sunroof systems, when installed, can increase the overall weight of the vehicle. Increasing the overall weight of the vehicle can affect fuel economy.

The quality of the images that can be displayed by high definition screens are greatly improving. The cost of such high definition screens is decreasing. Accordingly, it is desirable to provide methods and systems for using a high definition screen to simulate features that impact vehicle cost, such as a sunroof or any other feature. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for providing a virtual reality experience to an occupant of a vehicle. In one embodiment, a system includes a high definition screen associated with a component of a passenger compartment of the vehicle. The system further includes a control module communicatively coupled to the screen and configured to generate control signals that control virtual reality content to be displayed on the high definition screen.

### DESCRIPTION OF THE DRAWINGS

The exemplary embodiments will hereinafter be described in conjunction with the following drawing figures, wherein like numerals denote like elements, and wherein:

FIG. 1 is an illustration of a top perspective schematic view of a vehicle having a virtual reality system in accordance with various embodiments;

FIG. 2 is a functional block diagram illustrating the virtual reality system in accordance with various embodiments; and

FIG. 3 is a flowchart illustrating a method of controlling content to be displayed on a screen of the virtual reality system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to an application specific integrated circuit (ASIC), an electronic circuit, a processor (shared, dedicated, or group) and/or memory that executes or stores one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number of hardware, software, and/or firmware components configured to perform the specified functions. For example, exemplary embodiments may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that exemplary embodiments may be practiced in conjunction with any number of control systems, and that the vehicle systems described herein are merely exemplary embodiments.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

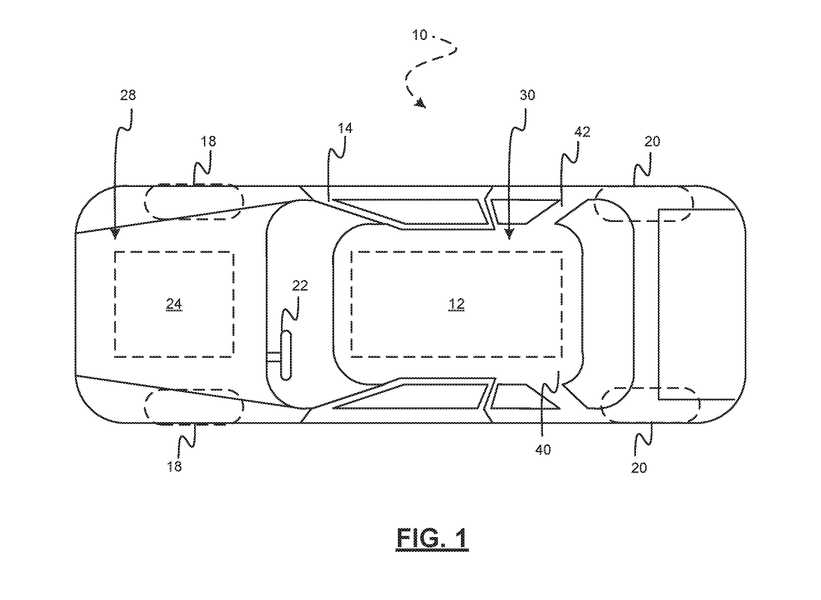

FIG. 1 is an illustration of a view of a vehicle shown generally at 10 equipped with a virtual reality system 12 in accordance with various embodiments. As will be discussed in more detail below, the virtual reality system 12 generally uses a high definition screen along with customizable software to allow a user to experience a virtual reality of a feature of the vehicle 10. As used herein, virtual reality is a replication of an environment, real or imagined. For example, the virtual reality system 12 can be implemented to provide all of the features of a real sunroof of the vehicle 10. In such examples, the high definition screen can be placed in any location of the roof of the vehicle 10 and can display images and/or videos that create a virtual reality of the sunroof. The images and/or videos can depict, for example, an inside of the roof, a glass pane, a scene outside of the vehicle (e.g., a sunshiny day, a starry night, etc.), a sunroof opening, a sunroof closing, etc. The images and/or videos may be realtime and/or pre-stored. As will be discussed in more detail below, the virtual reality system 12 can provide further features of the sunroof or other feature including, but not limited to visual features, sound features, aroma features, lighting features, and airflow features by controlling other systems of the vehicle 10. As will be discussed in more detail below, the virtual reality system 12 can integrate entertainment with the virtual reality for example, by displaying images and/or videos having entertainment content on all or part of the screen.

Although the context of the discussion herein is with respect to a vehicle, in particular a passenger car, it should be understood that the teachings herein are compatible with all types of automobiles including, but not limited to, sedans, coupes, sport utility vehicles, pickup trucks, minivans, full-size vans, trucks, and buses as well as any other type of autonomous, partial autonomous or non-autonomous automobile having a passenger compartment. Furthermore, the teachings herein are not limited to use only with automobiles but rather, may be used with other types of vehicles as well. For example, the teachings herein may be compatible with vehicles including, but not limited to, aircraft, railway cars, and watercraft. Additionally, the teachings herein may also be implemented in stationary applications such as buildings, residences, and any other structure traditionally having a window or other opening.

As shown in the example of FIG. 1, the vehicle shown generally at 10 generally includes a body 14, front wheels 18, rear wheels 20, a steering system 22, and a propulsion system 24. The wheels 18-20 are each rotationally coupled to the vehicle 10 near a respective corner of the body 14. The wheels 18 and/or 20 are driven by the propulsion system 24. The wheels 18 are steerable by the steering system 22.

The body 14 is arranged on or integrated with a chassis (not shown) and substantially encloses the components of the vehicle 10. The body 14 is configured to separate a powertrain compartment 28 (that includes at least the propulsion system 24) from a passenger compartment 30 that includes, among other features, seating (not shown) for one or more occupants of the vehicle 10. The virtual reality system 12 is shown to be associated with the passenger compartment 30 of the vehicle 10. As can be appreciated, the virtual reality system 12 can be associated with other parts of the vehicle, and is not limited to the present examples. For example, the virtual reality system 12 can be associated with an exterior portion of the vehicle 10 in various embodiments.

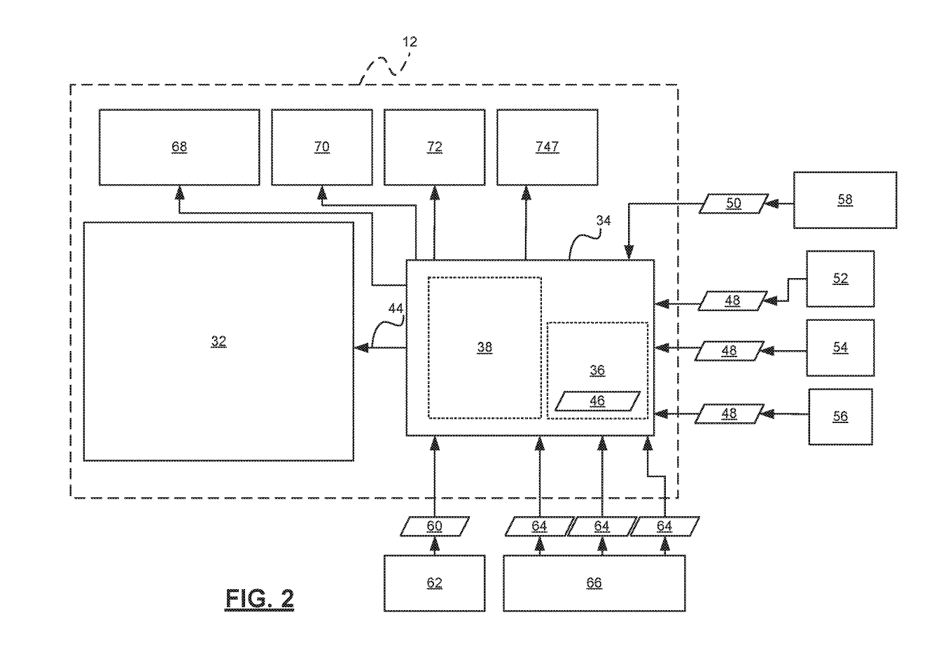

As shown in more detail in FIG. 2 and with continued reference to FIG. 1, the virtual reality system 12 includes a screen 32 communicatively coupled to a control module 34. While only one screen 32 is illustrated and described herein, in various embodiments, multiple screens can be implemented. The screen 32 is a high definition screen (e.g., LED, LCD, plasma, etc.) that is curved, flat, or combination thereof. In various embodiments, the control module 34 includes at least memory 36 and a processor 38. The control module 34 controls the screen 32 directly and/or communicates data to the screen 32 such that certain content can be displayed.

The screen 32 is integrated with a component of the body 14 that defines the passenger compartment 30, such as, but not limited to, a roof 40 or a pillar 42. In such embodiments, the orientation of the screen 32 is such that passengers, when seated in the passenger compartment 30 can view the screen 32. For example, when the screen 32 is associated with the roof 40 of the body 14, the screen 32 is oriented such that when a passenger is seated (and optionally reclined) and facing up at the roof 40, the screen 32 can be viewed (e.g., a viewing side of the screen 32 is facing down into the passenger compartment 30).

The screen 32 displays content such that a virtual reality is experienced by the viewer. As will be discussed in more detail below, the virtual reality can be realtime and/or can be predefined. The screen 32 further displays content such that entertainment is experienced by the viewer. The entertainment can be experienced in addition to or as an alternative to the virtual reality.

In various embodiments, the screen 32 displays the virtual reality and/or the entertainment content based on signals 44 received from the control module 34. The control module 34 may be dedicated to the screen 32, may control the screen 32 and other features of the vehicle 10 (e.g., a body control module, an instrument control module, or other feature control module), and/or may be implemented as a combination of control modules that control the screen 32 and other features of the vehicle 10. For exemplary purposes, the control module 34 will be discussed and illustrated as a single control module that is dedicated to the screen 32.

The control module 34 selectively generates the signals 44 to the screen 32 based on stored data 46, received data 48, and/or recorded data 50. The stored data 46 can include, for example, images and/or videos. The images and/or videos include lighting, surface textures, surface colors, pictures, scenes, animations, etc. that create the virtual reality and/or the entertainment. The stored data 46 can be pre-stored in the memory 36 of the control module 34, for example, by a vehicle manufacturer during production, and/or during a maintenance activity.

In various embodiments, the received data 48 can be received from a personal device 52 (e.g., a cell phone, a tablet, a personal computer, etc.), received from a remote system 54 (e.g., a remote server, or other system), and/or received from another vehicle 56. For example, the personal device 52, the remote system 54, and/or the other vehicle 56 communicate data stored by the respective system or device to the control module 34. The data can include, for example, images and/or videos. The images and/or videos include lighting, surface textures, surface colors, pictures, scenes, animations, etc. that create the virtual reality and/or the entertainment. The communication from the personal device 52, the remote system 54, and/or the other vehicle 56 may be via Bluetooth, WI-Fi, satellite, or any other long range or short range communication medium.

In various embodiments, the recorded data 50 can be from a camera 58 (e.g., a high definition digital camera, or other type of camera). For example, the camera 58 records data and communicates the recorded data 50 to the control module 34. The recorded data 50 include images or videos of scenes associated with the vehicle 10. For example, in order to create a virtual reality of a sunroof being open or an element not being present (e.g., no pillar) in realtime, the camera 58 records a scene that is opposite of the viewing side of the screen 32. For example, when the screen 32 is integrated with the roof 40 of the passenger compartment 30, the camera 58 is configured to record the scene above the roof 40, towards the sky. In another example, when the screen 32 is integrated with the pillar 42 of the passenger compartment 30, the camera 58 is configured to record the scene outside of the pillar 42, away from the vehicle 10.

In any of the examples, the stored data 46, the received data 48, and/or the recorded data 50 may be communicated to the control module 34 and stored for future use and/or may be streamed to the control module 34 for immediate use.

The control module 34 selectively controls the content to be displayed on the screen based on various inputs. For example, the control module 34 selectively controls the content based on user input data 60 received from a user input device 62. The user input device 62 may be part of the vehicle 10, part of the personal device 52, part of the remote system 54, and/or part of the other vehicle 56. In another example, the control module 34 automatically controls the content to be displayed based on an evaluation of context information 64 (e.g., vehicle location, time of day, weather, etc.) received from other vehicle systems or systems associated with the vehicle 66.

As further shown in FIG. 2, the virtual reality system 12 may further include a heating ventilation and cooling (HVAC) system 68, a sound system 70, a lighting system 72, and/or an aroma system 74 communicatively coupled to the control module 34. The control module 34 controls one or more of the systems 68-74 based on the content currently being displayed by the screen 32. The systems 68-74 are controlled to enhance the virtual reality experience of the passenger. For example, the control module 34 controls sounds generated by the sound system 70. Given the sunroof example, when the screen 32 displays an open sunroof, the sounds are controlled to mimic sounds that occur when a sunroof is open. As can be appreciated, the control of the sound system 70 is not limited to the present examples as other control methods to enhance the user's virtual reality experience are contemplated in various embodiments.

In another example, the control module 34 controls airflow provided by the HVAC system 68. Given the sunroof example, when the screen 32 displays an open sunroof, the airflow is controlled to mimic airflow that occurs when a sunroof is open. As can be appreciated, the control of the HVAC system 68 is not limited to the present examples as other control methods to enhance the user's virtual reality experience are contemplated in various embodiments.

In still another example, the control module 34 controls lighting in the vehicle 10 by the lighting system 72. Given the sunroof example, when the screen 32 displays an open sunroof, the lighting is controlled to mimic the lighting that occurs when the sunroof is open. As can be appreciated, the control of the lighting system 72 is not limited to the present examples as other control methods to enhance the user's virtual reality experience are contemplated in various embodiments.

In still another example, the control module 34 controls the aroma in the vehicle 10 by the aroma system 74. Given the sunroof example, when the screen 32 displays an open sunroof, the aroma is controlled to mimic a smell that may exist outside when the sunroof is open. As can be appreciated, the control of the aroma system 74 is not limited to the present examples as other control methods to enhance the user's virtual reality experience are contemplated in various embodiments.

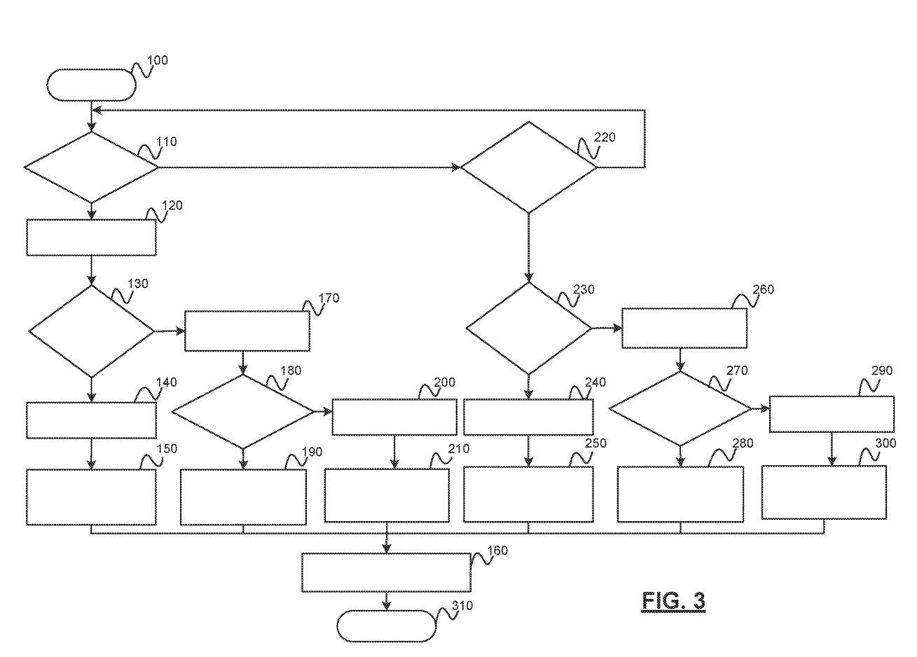

With reference now to FIG. 3 and with continued reference to FIGS. 1 and 2, a flowchart illustrates a method of controlling content to be displayed on the screen in accordance with various embodiments. As can be appreciated in light of the disclosure, the order of operation within the method is not limited to the sequential execution as illustrated in FIG. 3, but may be performed in one or more varying orders as applicable and in accordance with the present disclosure.

As can further be appreciated, the method of FIG. 3 may be scheduled to run at predetermined time intervals during operation of the screen 32 or vehicle 10 and/or may be scheduled to run based on predetermined events.

In one example, the method may begin at 100. It is determined whether user input data is received (e.g., based on a user interacting with a user input device) at 110. If user input is received at 110, the user input is processed at 120 to determine what the user input is indicating. It is determined whether the user input indicates to receive data at 130. If the user input does not indicate to receive data at 130, rather the user input data indicates to use already stored data, the stored data is retrieved from the memory at 140; and display signals are generated to display the content based on the stored data at 150. Thereafter, the screen receives the display signals and displays the content at 160.

If, at 130, the user input indicates to receive data, the data is received and processed at 170. If the processed data is streamed data at 180, display signals are generated to display the streamed content at 190. Thereafter, the screen receives the display signals and displays the content at 160. If, however, at 180, the processed data is not streamed data, the processed data is stored at 200 and the display signals are generated to display the stored content at 210. Thereafter, the screen receives the display signals and displays the content at 160.

If, at 110, user input is not received, an evaluation of the context information is performed to determine whether the context information indicates to display certain content at 220. If the context information does not indicate to display certain content, the method may continue to monitor for user input data at 110 (alternatively the method may end at 310—flow not shown). If the context information indicates to display certain content at 220, it is determined whether the context indicates to use received data at 230. If it is determined to not use received data at 230, rather the to use already stored data, the stored data is retrieved from the datastore at 240; and display signals are generated to display the content based on the stored data at 250. Thereafter, the screen receives the display signals and displays the content at 160.

If, at 230, it is determined to use received data, the data is received and processed at 260. If the processed data is streamed data at 270, display signals are generated to display the streamed content at 280. Thereafter, the screen receives the display signals and displays the content at 160. If, however, at 270, the processed data is not streamed data, the processed data is stored at 290 and the display signals are generated to display the stored content at 300. Thereafter, the screen receives the display signals and displays the content at 160.

Once the content is displayed on the screen, the method may end at 310.

Optionally, at or after 160, one or more control signals can be generated by the control module 34 to control one or more of HVAC system 68, the sound system 70, the lighting system 72, and the aroma system 74 to add to the virtual experience.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A system for providing a virtual reality experience to an occupant of a vehicle, comprising:
a display screen integrated with a component of a passenger compartment of the vehicle; and
a non-transitory control module communicatively coupled to the display screen and configured to, by a processor, generate control signals that control virtual reality content to be displayed on the display screen.

2. (canceled)

3. The system of claim 1, wherein the component is a roof of the passenger compartment.

4. The system of claim 3, wherein the virtual reality content includes images of at least one of an inside of the roof, a glass pane, and a scene outside of the vehicle.

5. The system of claim 3, wherein the virtual reality content includes a video of at least one of a sunroof opening, and a sunroof closing.

6. The system of claim 1, wherein the component is a pillar of the passenger compartment.

7. The system of claim 6, wherein the virtual reality content includes at least one of images and videos of a scene outside of the vehicle.

8. The system of claim 1, wherein the virtual reality content is based on recorded data from a camera.

9. The system of claim 1, wherein the virtual reality content is based on received data from at least one of a personal device, a remote system, and another vehicle.

10. The system of claim 1, wherein the virtual reality content is streamed to the control module.

11. The system of claim 1, wherein the virtual reality content is communicated to the control module and stored.

12. The system of claim 1, wherein the virtual reality content is based on stored data that is pre-stored in the control module.

13. The system of claim 1, wherein the control module generates the control signals to the high definition screen based on user input data received from a user input device.

14. The system of claim 13, wherein the user input device is associated with the vehicle.

15. The system of claim 13, wherein the user input device is associated with at least one of a personal device, a remote system, and another vehicle.

16. The system of claim 1, wherein the control module generates the control signals to the display screen based on context data received from other systems associated with the vehicle.

17. The system of claim 1, further comprising a heating, ventilation, and cooling (HVAC) system communicatively coupled to the control module, wherein the control module is further configured to generate control signals to the HVAC system that control airflow in the passenger compartment that corresponds with the virtual reality content.

18. The system of claim 1, further comprising a lighting system communicatively coupled to the control module, wherein the control module is further configured to generate control signals to the lighting system that control lighting in the passenger compartment that corresponds with the virtual reality content.

19. The system of claim 1, further comprising an aroma system communicatively coupled to the control module, wherein the control module is further configured to generate control signals to the aroma system that control an aroma in the passenger compartment that corresponds with the virtual reality content.

20. The system of claim 1, further comprising a sound system communicatively coupled to the control module, wherein the control module is further configured to generate control signals to the sound system that control a sound in the passenger compartment that corresponds with the virtual reality content.

21. The system of claim 1, wherein the control module is further configured to generate control signals that control entertainment content to be displayed on the display screen.
